(19) United States
(12) Patent Application Publication
(10) Pub. No.: US 2025/0153565 A1
(43) Pub. Date: May 15, 2025

(54) SHORT-STROKE INDUCTIVE SENSOR

(71) Applicant: HELLA GmbH & Co. KGaA, Lippstadt (DE)

(72) Inventors: Henning IRLE, Lippstadt (DE); Carsten KUEGELER, Lippstadt (DE); Roman SCHAMNE, Lippstadt (DE)

(73) Assignee: HELLA GmbH & Co. KGaA, Lippstadt (DE)

(21) Appl. No.: 18/947,936

(22) Filed: Nov. 14, 2024

(30) Foreign Application Priority Data
Nov. 14, 2023 (DE) 10 2023 131 693.1

(51) Int. Cl. B60K 26/02; G05G 1/38

(52) U.S. Cl. CPC B60K 26/02; G05G 1/38

(57) ABSTRACT

A sensor for detecting a short-stroke movement, in particular for a pedal of a vehicle. The sensor has a first wing structure. A second wing structure is spaced apart from the first wing structure along a stroke direction. A sensor circuit board is provided for sensor-based detection of a movement of the first wing structure and/or second wing structure, the sensor circuit board being situated between the first wing structure and the second wing structure. A sleeve connects the first wing structure and the second wing structure, the sleeve being situated so that it is movable with respect to the sensor circuit board.

This nonprovisional application claims priority under 35 U.S.C. § 119(a) to German Patent Application No. 10 2023 131 693.1, which was filed in Germany on Nov. 14, 2023, and which is herein incorporated by reference.

### BACKGROUND OF THE INVENTION

### Field of the Invention

The invention relates to a sensor, to a method, to a computer program product, to a computer-readable data medium, to a control unit, and to a vehicle.

### Description of the Background Art

Sensors for pedals of vehicles, for example an accelerator pedal or clutch pedal in a conventional passenger car, are known. A cable pull may be used, as originally. More recent variants may have a decoupled pedal, wherein only the stroke of the pedal that is applied by the foot of the driver is detected, on the basis of which the engine is regulated and/or controlled. Other pedals and systems may use such sensors for the stroke. In the areas of steering and braking, the so-called X-by-wire systems have apparently become established now. The driver's intent is detected using force sensors and/or position sensors, and an electronic control unit (ECU) regulates the control task via an actuator. Thus, for example, for steer-by-wire, the wheels are adjusted for steering. All X-by-wire applications are classified as safety-relevant systems, and in particular are usually classified as an ASIL-D level under ISO 26262.

However, the prior art has various drawbacks. Known sensors are designed for only a comparatively large stroke, for example approximately 60 mm, and/or for a small stroke of approximately 10 mm, for example, allow only low or insufficient accuracy. In comparison, small sensors and components are sensitive and/or not adequately robust. In addition, known sensors or systems have insufficient flexibility. Thus, parts cannot be modularly exchanged. The components, such as sensor circuit boards, which are designed for angular measurement are or can be used only for this application. The situation is similar for path sensors or corresponding sensor circuit boards, which have a very specific design and are used only for this purpose. Sensor circuit boards, such as those known from semiconductor technology (PCBs), cannot implement any desired conductor track routing. Consequently, miniaturization of known sensors is limited. Path sensors with a measuring path less than approximately 5 mm are difficult or impossible to implement. Path sensors on sensor circuit boards, such as the CIPOS® technology, may be unsuitable for measuring short measuring paths in a range of approximately 10 mm. Very filigreed conductor track structures on the sensor circuit boards or PCBs would be necessary for the small paths. This is generally not in accord with guidelines for semiconductor design for automotive applications. Miniaturized short-stroke sensors also require very narrow mechanical tolerances for manufacture, installation, and/or maintenance, as well as in particular precise guiding and/or a precisely designed housing. The mechanical tolerances may be particularly exacting with eccentricity and/or tilting. Furthermore, known sensors and designs are too complicated and/or too costly. Designs made of plastic are usually chosen, but such designs may not be very compatible with the mechanical tolerance requirements for miniaturized inductive path sensors. In addition, test conditions in the automotive sector are very challenging, for example with regard to magnetic components, which should enable leakage field immunity for magnetic interference fields having a field strength of presently 4000 A/m. Accordingly, the stringent safety requirements must be met, and/or preferably the risk of common mode failures must be averted, wherein a certain disturbance variable (at least theoretically) prevents the overall functioning of the sensor.

### SUMMARY OF THE INVENTION

It is therefore an object of the present invention to at least partially overcome at least one of the drawbacks described above. In particular, the object of the invention is provide a simple, cost-effective, robust, and/or less error-susceptible short-stroke sensor device.

The above object is achieved, in an example, by a sensor, by a method, by a computer program product, by a computer-readable data medium, by a control unit, and by a vehicle. Features and details that are described in conjunction with the sensor according to the invention naturally also apply in conjunction with the method according to the invention and/or in conjunction with the computer program product according to the invention and/or in conjunction with the computer-readable data medium according to the invention and/or in conjunction with the control unit according to the invention and/or in conjunction with the vehicle according to the invention, and vice versa in each case, so that with regard to the disclosure, reciprocal reference is or may always be made to the individual aspects of the invention. In particular, advantages that are described within the scope of the first, second, third, fourth, fifth, and/or sixth aspect also apply in each case for the first, second, third, fourth, fifth, and/or sixth aspect.

According to a first aspect, the above object is achieved by a sensor for detecting a short-stroke movement, in particular for a pedal of a vehicle, including: a first wing structure, a second wing structure that is spaced apart from the first wing structure along a stroke direction, a sensor circuit board for sensor-based detection of a movement of the first wing structure and/or second wing structure, the sensor circuit board being situated between the first wing structure and the second wing structure, and a sleeve that connects the first wing structure and the second wing structure, the sleeve being situated so that it is movable with respect to the sensor circuit board.

A short-stroke movement or a short stroke may have a stroke of less than 50 mm, preferably less than 30 mm, particularly preferably less than 15 mm, advantageously less than 10 mm, ideally less than 5 mm.

This type of sensor may preferably be used, for example, in a pedal for a vehicle, such as a brake pedal, a clutch pedal, or an accelerator pedal. The sensor and/or the pedal may thus advantageously have a particularly short stroke. Convenient actuation is thus possible. In addition, the sensor and/or the pedal may be depressed in a particularly simple and/or space-saving manner, so that the pedal preferably is no longer interfering and/or visible.

A stroke that is applied, for example, by a driver, in particular along a stroke direction, to a pedal that is mechanically coupled to the sensor may preferably be detected. A pedal including a sensor may thus be provided which has the advantages.

The first wing structure, second wing structure, and/or sensor circuit board may be situated planarly, flatly, and/or in parallel to one another. This may result in a particularly flat design which in particular saves space. In addition, greater robustness may thus be achieved.

The sleeve, in particular the longitudinal axis or symmetry axis, may be situated essentially perpendicular to the first wing structure, second wing structure, and/or sensor circuit board. This may result in a geometrically robust overall design. The sleeve may represent a spacer element and/or connecting element. The sleeve preferably connects the first and second wing structures, in particular mechanically. The shape of the sleeve, as described below, may have different geometric configurations. The sleeve may have a rectangular or square, preferably longitudinally extended, cross section, and in particular may be hollow. The sleeve may have the shape of a cylinder surface. The sleeve may have a length between 0.1 and 100 mm, preferably between 0.5 and 60 mm, more preferably between 1 and 40 mm, particularly preferably between 3 and 20 mm, ideally between 4 and 13 mm. The sleeve may have a diameter between 0.1 and 200mm, preferably between 1 and 100 mm, more preferably between 3 and 70 mm, particularly preferably between 5 and 50 mm, ideally between 7 and 20 mm. The sleeve may have a wall thickness between 0.01 and 10 mm, preferably between 0.1 and 5 mm, more preferably between 0.5 and 4 mm, particularly preferably between 0.7 and 3 mm, ideally between 1 and 2 mm. A cylinder surface may save on weight and costs and/or may be easy to manufacture. It may also be provided to use a solid cylinder, in particular to increase the robustness and/or precision. A smaller size may minimize the installation space and/or the weight. Comparatively larger dimensions may provide greater precision and/or facilitate manufacturing. The sleeve may include a metal, for example stainless steel, which is advantageously economical, precisely machinable, and/or robust. Alternatively or additionally, aluminum, which is advantageously lightweight and/or easily formable, may be included. Metals also have high chemical resistance. Alternatively or additionally, the sleeve may include a nonmetallic material, in particular a plastic. Weight may thus be saved and/or greater ease of manufacture may be achieved.

The first wing structure and/or second wing structure, in particular the longitudinal axis or symmetry axis, may be situated essentially perpendicular to the sleeve. This may result in a geometrically robust overall design. The first wing structure and/or second wing structure may have the form of a plate or a flat cube. It may be provided that the wing structures have a symmetrical design around the stroke direction, and advantageously have a star shape and/or gearwheel-like design.

The first wing structure and/or second wing structure may have a preferably uniform thickness, in particular along the stroke direction (also referred to as the z direction), that is between 0.1 and 100 mm, preferably between 0.01 and 10 mm, preferably between 0.1 and 5 mm, more preferably between 0.5 and 4 mm, particularly preferably between 0.7 and 3 mm, ideally between 1 and 2 mm. The first wing structure and/or second wing structure may have a diameter, in particular perpendicular to the stroke direction along an x direction and/or y direction, that is between 1 and 200 mm, preferably between 10 and 100 mm, more preferably between 20 and 80 mm, particularly preferably between 30 and 70 mm, ideally between 40 and 60 mm. The x direction, the y direction, and the z direction may form a right-hand system. It may also be provided that the first wing structure and/or second wing structure have/has a longitudinal extension along the x and/or y direction that is between 1 and 200 mm, preferably between 10 and 100 mm, more preferably between 20 and 80 mm, particularly preferably between 30 and 70 mm, ideally between 40 and 60 mm, in particular when the shape of an outer border is essentially not circular, but, rather, rectangular or square (see below, in particular for different wing lengths). A smaller size may minimize the installation space and/or the weight. Comparatively smaller dimensions may provide greater precision and/or facilitate manufacturing. The first wing structure and/or second wing structure may include a metal, for example stainless steel, which is advantageously economical, precisely machinable, and/or robust. Alternatively or additionally, aluminum, which is advantageously lightweight and/or easily formable, may be included. Metals also have high chemical resistance.

The spacing between the first and second wing structures may be determined by the sleeve, which preferably connects same. The spacing may have a value between 0.1 and 200 mm, preferably between 1 and 100 mm, more preferably between 2 and 20 mm, particularly preferably between 3 and 15 mm, ideally between 4 and 8 mm. The spacing may preferably correspond essentially to the stroke, which may be (maximally) ascertained by the sensor.

The sensor may be designed as an inductive sensor. The physical utilization of induction may be particularly advantageous, in particular for the stroke that is to be detected. Inductive sensors are advantageously robust against many interfering influences. For example, they have high temperature stability, in particular between −40° C. and 160° C. In addition, they may have high precision and/or be robust with regard to a mechanically unfavorable configuration, in particular inclined positions, misalignment, etc.

The sensor circuit board may include an integrated circuit. The sensor circuit board may thus have, for example, a preferably inductive measurement sensor (a sensor element, for example) that can detect an approach toward and/or distance from the first and/or second wing structure. This may be achieved, for example, using conductor loops (in particular open coils) and/or a planarly designed coil in the sensor circuit board. Even during manufacture, they may be produced precisely according to the requirements, in particular depending on the overall sensor. For example, the conductor loops may be situated essentially along the stroke direction, in flush alignment relative to the wings. Accordingly, different conductor loops, in particular that are insulated from one another, may be used for the first and/or second wing structure. They may be protected particularly well from external environmental influences due to the encapsulation in the sensor circuit board. An inductive short-stroke sensor with linear measurement, in particular for strokes less than or equal to approximately 10 mm, may thus be provided. The sensor circuit board may preferably encompass a known sensor circuit board, for example a CIPOS rotation angle sensor. A rotation angle sensor may thus preferably be used to detect the preferably complete linear stroke. In other words, the stroke may thus be converted into a “virtual” rotation of a rotation angle sensor. In addition, it is advantageously possible to use known components which in particular are optimized, fully developed, economical, robust, and/or proven. The conductor loops, in particular planar coils, may be manufactured with narrow tolerances of printed circuit board (PCB) production. The printed circuit board may be manufactured essentially by a photolithographic process, in particular followed by an etching process, and therefore has very narrow tolerances relative to the overall sensor size. This may allow a particularly precise adaptation to a desired sensor and/or to its properties.

It may be particularly preferred for the first wing structure, the second wing structure, the sleeve, and/or the sensor circuit board to be nonrotatable relative to one another, in particular, for none of the parts to rotate. A purely linear stroke movement, in particular a reversible stroke movement, may thus be provided. This may result in a more robust design. In particular, the influence of misalignments may thus be reduced or prevented.

The sensor circuit board may have a preferably uniform thickness, in particular along the stroke direction (also referred to as the z direction), of between 0.1 and 100 mm, preferably between 0.01 and 10 mm, preferably between 0.1 and 5 mm, more preferably between 0.5 and 4 mm, particularly preferably between 0.7 and 3 mm, ideally between 1 and 2 mm. The sensor circuit board may have a diameter, in particular perpendicular to the stroke direction along an x direction and/or y direction, that is between 1 and 200 mm, preferably between 10 and 100 mm, more preferably between 20 and 80 mm, particularly preferably between 30 and 70 mm, ideally between 40 and 60 mm. It may also be provided that the sensor circuit board has a longitudinal extension along the x and/or y direction that is between 1 and 200 mm, preferably between 10 and 100 mm, more preferably between 20 and 80 mm, particularly preferably between 30 and 70 mm, ideally between 40 and 60 mm, in particular when the shape of an outer border is essentially not circular, but, rather, rectangular or square. In addition, the sensor circuit board may be advantageously accommodated in a housing. A smaller size may minimize the installation space and/or the weight. Comparatively larger dimensions may provide greater precision and/or facilitate manufacturing. The sensor circuit board may include a metal, for example stainless steel and/or copper, which is advantageously economical, precisely machinable, and/or robust. Alternatively or additionally, aluminum, which is advantageously lightweight and/or easily formable, may be included. A noble metal, for example gold, which has particularly good conductivity may also be provided for the conductor tracks. Metals also have high chemical resistance. The conductor tracks may be enclosed by a printed circuit board material, in particular molded therein. This may be an insulator. For example, an epoxy resin having particularly high mechanical robustness may be provided. The sensor circuit board, in particular perpendicular to the stroke direction, preferably has essentially the same size as the first and/or second wing structure, and in particular is essentially congruent with same. The weight and/or the installation space may be optimized in this way.

The sensor, the sleeve, the first wing structure, the second wing structure, and/or the sensor circuit board preferably have a comparatively short stroke compared to the dimensions in the plane perpendicular thereto. As a result, a short stroke may be measured and/or low susceptibility to tolerances, inclined positions, and/or deviations may be made possible. The installation space may be comparatively small, in particular flat. Manufacture may be comparatively simple and/or cost-effective due to the greater extension perpendicular to the stroke direction.

The sensor circuit board may be guided on the sleeve, for example using an opening in the sensor circuit board to movably guide the sleeve through it. It may thus be provided that the sleeve functions as a guide, in particular along the stroke direction, wherein the sensor circuit board is stationary, in particular relative to a housing and/or vehicle, and the sleeve, the first wing structure, and/or the second wing structure move relative to the sensor circuit board, for example during a movement of a coupled pedal.

The first wing structure and the second wing structure may preferably be connected, in particular rotatably fixedly connected, via the sleeve. This may result in a particularly stable design. In addition, the first wing structure, the second wing structure, and/or the sleeve may have a one-piece design, and for example may be punched from a part. This may allow particularly cost-effective manufacture. A particularly robust design may be achieved due to the integral bond. In addition, a particularly precise and/or robust parallel design of the wing structures may result. It is thus possible to increase the overall precision and/or robustness with regard to misalignments of the sensor, in particular since only a precise alignment with respect to the sensor circuit board can then influence the measurement.

It may be provided that the first wing structure and the second wing structure are electrically insulated from one another. This may reduce the susceptibility to interference, for example for in-coupling of electromagnetic waves.

The first wing structure, the second wing structure, and/or the sensor circuit board may preferably be layered essentially one above the other, in particular in a sandwich-like manner, in particular situated in parallel. A space-saving and/or robust arrangement may advantageously result. This may be advantageous in particular due to the fact that a displacement caused by the structure and/or an application of force, for example, has only a negligible effect on the functionality of the sensor. A particularly robust design may thus be achieved.

Within the scope of the invention, it may be advantageous for the first wing structure to have at least one first wing and at least one first wing gap, and/or for the second wing structure to have at least one second wing and at least one second wing gap.

It may be provided that the first and/or second wing structure, in particular in the area adjoining the sleeve, have/has an annular design. An annular area may have a width, in particular perpendicular to the stroke direction, that is between 0.1 and 100 mm, preferably between 0.5 and 60 mm, more preferably between 1 and 40 mm, particularly preferably between 3 and 20 mm, ideally between 4 and 13 mm. It may be provided that the wings and/or wing gaps adjoin the annular area, in particular perpendicular to the stroke direction. This may result in a star shape and/or gearwheel-like design.

The wing gaps may advantageously be designed to save material, weight, and/or costs. In addition, the wing gaps may be utilized to allow the sensor circuit board to distinguish between the first and second wing structures, for example by rotating the first and second wing structures relative to one another (see below).

It may be provided that the first wing structure has a first number of wings and/or a first number of wing gaps between 1 and 100, preferably between 2 and 50, more preferably between 3 and 20, particularly preferably between 5 and 15, advantageously between 7 and 10, ideally 9.

It may be provided that the second wing structure has a second number of wings and/or a second number of wing gaps between 1 and 100, preferably between 2 and 50, more preferably between 3 and 20, particularly preferably between 5 and 15, advantageously between 7 and 10, ideally 9.

For example, three wings may be an optimal (respective) number of wings for a sensor for a throttle valve. This may be determined by simulations, for example, which in particular include the conditions of the actual application.

A greater number of wings may benefit signal processing, and in particular a stronger measuring signal may result, for example because a higher current and/or a higher voltage is induced.

It may be advantageous when both wing structures have the same number of wings. This may allow particularly easy manufacture, in particular since symmetry may result, and thus in particular installation may be independent of the mounting orientation.

It may also be advantageous when the wing structures have different numbers of wings, in particular to simplify sensor-based detection. For example, due to a different number of wings, an induced voltage and/or an induced current may be different, which may allow a conclusion as to which wing structure is involved. This may be used as an alternative or in addition to inductive detection as such.

The first and/or second wing structure, in particular the wings and/or wing gaps, may have an essentially or completely identical design. This may allow particularly simple, advantageous, and/or precise manufacture.

It may be provided, for example, that the first and/or second wing structure are/is punched from a planar (for example, a flat square) workpiece. The first and/or second wing structure may thus be circular. It may be provided that the wings gaps are punched and in particular the wings remain.

It may be provided that some wings of the first and/or second wing structure are omitted and/or shortened, so that in particular an essentially rectangular shape results, in particular perpendicular to the stroke direction. This may be advantageous for making optimal use of specifications for an available installation space.

Within the scope of the invention, it is conceivable for the first wing structure to be displaceable, essentially up to the sensor circuit board, along the stroke direction until reaching a first end position, and/or for the second wing structure to be displaceable, essentially up to the sensor circuit board, along the stroke direction until reaching a second end position.

An end position, in particular reaching the end position, may mean that the first or second wing structure cannot be brought closer to the sensor circuit board. This may also mean that the sensor circuit board is contacted, preferably without resulting in an electrical connection. In a first end position the first wing structure may be situated right next to the sensor circuit board, wherein the second wing structure is then situated at a maximum distance from the sensor circuit board, wherein the sensor circuit board can then measure a first angle (ALPHA) which is exclusively or almost exclusively specified by the first wing structure. In a second end position the second wing structure may be situated right next to the sensor circuit board (in particular from the other side), wherein the first wing structure is then situated at a maximum distance from the sensor circuit board, wherein the sensor circuit board can then measure a second angle (BETA) which is exclusively or almost exclusively specified by the second wing structure. ALPHA—BETA may correspond to the rotation angle by which the first wing structure is rotated relative to the second wing structure.

When a wing structure approaches the sensor circuit board, the approach may preferably be detected by the sensor circuit board. For example, this may take place inductively, in particular by the wing structure inducing a current and/or a voltage in the sensor circuit board, in particular in a conductor loop. By the configuration of the conductor loops or multiple conductor loops, it may be distinguished whether the first or the second wing structure is approaching and/or moving away. Thus, during a movement along the stroke direction from one end position to the other, the sensor signal may change, in particular as a function of the distance of the first and/or second wing structure from the sensor circuit board. The sensor signal may overlap with the stroke movement of the first and/or second wing structure, and in particular may be a function of same. The signal pattern of the resulting sensor signal is preferably a function of the distance, and in particular is proportional to same. The pattern of the sensor signal, in particular between the end positions, is preferably essentially linear. A magnetic field may be generated in the conductor loops (in particular open coils), wherein in particular the first and/or second wing structure change(s) the field when approaching and/or moving away. Angles, strokes or distances, and/or speeds may thus be measured in a contactless and/or wear-free manner. In the present case an angle is particularly preferably determined, for example via sensor circuit board that includes in particular a CIPOS structure. As a function of the position of the wings, in particular a rotation angle sensor can recognize which wing structure is approaching and/or moving away, preferably without the wing structure rotating. In other words, a rotation angle sensor may be used without anything rotating, and instead is used based on the number, size, and/or orientation of the at least one first and/or second wing. For example, a rotation angle sensor having a measuring range of 360°/9=40° may be implemented when a wing number of nine wings are situated at the first and/or second wing structure. It may be critical for the first and second wing structures to be rotated relative to one another, at least in part (see below). In other words, it may be provided that the first wings and the second wings are not completely in flush alignment along the stroke direction.

When a wing structure reaches an end position, the respective other first or second wing structure may then have a maximum distance from the sensor circuit board. The first and second wing structures may be rigidly connected to one another via the sleeve, for example by integrally joining them together (a punched piece or a cast piece, for example). It may also be provided that the first wing structure and/or the second wing structure are/is adhesively bonded or welded to the sleeve. Separate manufacture may thus be made possible to advantageously allow less expensive, more precise, and/or faster production. It may be provided to manufacture the entire structure as a (single) stamped/bent part, in particular in a single process, so that time and/or costs may be minimized.

Within the scope of the invention, it may be provided that the first wing structure and the second wing structure are rotated relative to one another, perpendicular to the stroke direction, about an in particular constant rotation angle, the rotation angle preferably being designed in such a way that the at least one first wing conceals essentially one-half of the at least one second wing gap, and the at least one second wing conceals essentially one-half of the at least one first wing gap.

A viewing direction for the rotation angle may be oriented between the wing structures, along the stroke direction. The first wing structure and the second wing structure are preferably not, or at least not completely, congruent. Ideally, it may be provided that the first wing structure and the second wing structure are rotated relative to one another in such a way that an average value between complete congruence and no congruence is achieved. The measuring signal may thus be advantageously optimized, in particular maximized. In addition, this may result in optimized robustness, in particular against misalignment. For example, when the first and second wing structures each have a wing number of four (first and second), it may be provided that the first wing structure is rotated by 22.5° relative to the second wing structure, in particular when a wing covers 45° and a wing gap likewise covers 45°, and the wings and wing gaps alternate in sequence (for which 0° would correspond to no rotation, and 45° would correspond to congruence of the wings between the first and second wing structures). It may thus be provided that for a wing number of N wings in each case which are arranged equidistantly along the circumference of the wing structures, the first wing structure is rotated by 360°/(N*2*2) relative to the second wing structure, resulting in particular in a factor of 2 due to the fact that wings and wing gaps alternate, and in particular resulting in a further factor of 2, so that “one-half” concealment of the wings may result.

It may be provided that for the overall angle of 360°, 50% is occupied by the wings and 50% is occupied by the wing gaps, which thus have the same length in particular relative to the circumference. This allows particularly simple manufacture. It may also be provided to set this ratio as a function of the design and/or the application of the sensor. Thus, for example, it may be provided to reduce the proportion of the wings to less than 50%, preferably to less than 45%, particularly preferably to less than 40%, more preferably to less than 30%, ideally to less than 20%, for example to save weight. The remaining portion may then be utilized by wing gaps. It may also be provided to reduce the proportion of the wing gaps to less than 50%, preferably to less than 45%, particularly preferably to less than 40%, more preferably to less than 30%, ideally to less than 20%, for example to obtain a higher induced voltage and/or current and thus in particular to allow more accurate measurement. The remaining portion may then be utilized by wings.

It may be provided that the offset between essentially superposed wings of the first and second wing structures is essentially constant.

It is also conceivable for the first wing structure and the second wing structure and/or the sleeve to be rotatably fixedly situated with respect to the sensor circuit board, wherein preferably the first wing structure, the second wing structure, and the sleeve are connected, in particular connected in one piece.

It may be provided that a movement of the first wing structure, the second wing structure, and/or the sleeve is possible along the stroke direction, preferably on both sides in the direction of the first and second end positions, while in particular the sensor circuit board is essentially stationary, in particular relative to a housing and/or a vehicle.

It may be provided that the sensor has a housing. It may be provided that the first wing structure, the second wing structure, the sleeve, and/or the sensor circuit board are enclosed, in particular entirely enclosed, by the housing. The sensor may thus be protected from external environmental influences, for example at least one environmental influence such as external application of force, soiling, moisture, and electrical and/or magnetic interferences. Accordingly, it may be provided that the sensor circuit board is not movable relative to the housing, while preferably the first wing structure, the second wing structure, and/or the sleeve can move relative to the housing, preferably uniformly or synchronously, in particular along the stroke direction, preferably exclusively along the stroke direction.

It is also conceivable for the first wing structure and the second wing structure to be coupled to one another and displaceable relative to the sensor circuit board along the stroke direction, in particular during external application of a stroke movement, for example by actuating a coupled pedal, and in particular for the sensor circuit board to not move during external application of a stroke movement, for example by actuating a coupled pedal.

The first and second wing structures may be mechanically coupled, in particular in such a way that the spacing between them remains the same. This may be achieved by means of the sleeve, for example (see above). A particularly robust design may be achieved in this way.

Within the scope of the invention, it is optionally possible for the sensor circuit board to have at least one sensor element for detecting an approach of the first wing structure and/or second wing structure.

It may be provided that a detection is carried out by the sensor circuit board for approaching and/or moving away. The at least one sensor element may include at least one conductor loop which preferably can generate a sensor signal by induction. Via the design of the sensor element, in particular the conductor loop, during construction the pattern of the sensor signal may be established as a function of the design of the other parts. This may allow an application-specific design.

Within the scope of the invention, it may be further provided that the first wing structure and the second wing structure include a conductive and/or ferromagnetic material, in particular a metal, and in conjunction with the sensor circuit board form an inductive sensor. It may be provided that no ferromagnetic material is used in order to generate (in particular) no additional phase shift, which can influence the sensor signal. The measuring accuracy may thus be increased. It may be provided to use a ferromagnetic material in order to generate an overall stronger sensor signal, which may be advantageous in particular when an application is planned in an environment that is known to be susceptible to interference. By use of a ferromagnetic, in particular conductive, material, different types of sensors may preferably be combined, for example an inductive sensor and a magnetic sensor.

A linear sensor, in particular a short-stroke sensor, may preferably be implemented.

The sensor circuit board may preferably be designed as a rotary sensor, in particular an angle of the first and/or second wing structure being ascertained by the sensor circuit board (although the wing structure itself does not rotate). This may be advantageous in order to use existing, and in particular well-developed, sensor circuit boards (CIPOS, for example). In addition, this may be advantageous since such rotary sensors allow precise measurement, and/or due to the fact that the resulting pattern of the sensor signals may be constant. A particularly accurate determination of the stroke may result in this way. It may also be provided that linearization of the sensor signal takes place. The determination of the stroke may thus be carried out even more accurately.

With regard to the present invention, for the redundant sensing it is conceivable for the sensor, in particular in addition to an (above-described) inductive measuring method, to implement a further, in particular different, physical measuring method, wherein in particular the first wing structure and the second wing structure have a conductive design and form a first and second capacitor plate, and together with the sensor circuit board form a three-layer plate capacitor.

The redundant sensing may use a distinct measuring method. Thus, a distinct sensor technology may be used which advantageously prevents so-called common mode faults, in particular in which a source of interference affects the entire sensor or makes it inoperative. Thus, this may mean that sensors are constructed or combined according to different basic physical principles. Optical, capacitive, magnetic, and/or inductive sensor technologies may thus be combined with one another. An external disturbance which, for example, interferes with an inductive measurement or makes it impossible may advantageously be compensated for by using a different type of measurement (or sensing), thus maintaining in particular the overall functionality of the sensor despite interference. Security may thus be increased, and in particular a total failure of the sensor may be prevented.

It may be provided that a plate capacitor is formed as capacitor plates by means of the wing structures, and the sensor circuit board is formed as a dielectric. At the same time, the sensor circuit board may sense a variable capacitance as a function of the stroke, thus in particular as a function of the distance between the first and/or second wing structure from the sensor circuit board. This may be advantageously used, in addition or as an alternative to the inductive measuring method, to provide redundancy. For example, a capacitor could be impaired by moisture, while some other measurement, for example inductive measurement, is affected less or not at all.

Alternatively or additionally, the sensor, in particular the sleeve, may include a magnet. The magnet may be integrated into an insulator, in particular plastic. The magnet may have helical magnetization. It may be provided that a stroke is correspondingly measured as virtual rotation, for example by the sensor circuit board having a CIPOS printed circuit board. In addition, the sensor, in particular the sensor circuit board, may include a magnetic sensor element, for example a Hall probe, for generating a magnetic sensor signal. A (further) redundant, in particular distinct, measuring method may thus be implemented. A greater number of redundancies may reduce the (overall) likelihood of failure of the sensor.

Alternatively or additionally, the sensor may include a path sensor technology that is based in particular on a CIPOS-based sensor circuit board. In this way, in particular analogously to the inductive variant described above, the stroke may be determined directly, and in particular not based on the rotation angle between the first and second wing structures. This may be made possible, for example, by a, in particular additional, modified winding technology. Alternatively or additionally, segment sensors may be used which may be designed, for example, as subsegments of a circle, and in particular integrated into the sensor circuit board. Accordingly, it may be provided that at least one upper cursor plate and at least one, in particular complementary and/or opposite, lower cursor plate are provided.

Furthermore, it is conceivable for the sleeve to have a spring, wherein the stroke of the spring is used to implement a force sensor.

This may be utilized in addition or as an alternative to the above sensor technologies, wherein the redundancy reduces in particular the likelihood of failure. Security may thus be increased, and in particular a total failure of the sensor may be prevented.

The spring may enclose, in particular entirely enclose, the sleeve. The spring may encompass a coil spring, which may be manufactured in a particularly simple manner. In particular for coil springs, the displacement with respect to the force may be very proportional, in particular linear. It may in particular be provided to design the spring, in particular its windings, in such a way that the displacement with respect to the force is essentially linear, for example due to changed spacings of the windings. Alternatively or additionally, the spring may encompass a disk spring, which can exert particularly homogeneous forces (entirely) on the sleeve. The position or the stroke may be determined via the sensor circuit board, in particular as described above. Based on the knowledge of the spring or its force curve, the force may thus be determined, for example via a control unit.

According to a second aspect, the above object is further achieved by a method according to the invention for a sensor for detecting a short-stroke movement, in particular for a pedal of a vehicle, comprising: providing a sensor; moving, in particular by a user, the first wing structure and/or second wing structure along a stroke direction toward a first or second end position; detecting by the sensor circuit board the movement for the sensor-based detection in order to provide a sensor signal; providing the sensor signal to a control unit; processing the sensor signal by the control unit to provide an output signal; and providing the output signal by the control unit, for example for operating a vehicle.

The control unit may be connected to the sensor circuit board, for example via a data link. The control unit may preferably be configured to control and/or regulate the sensor circuit board. The detection of the movement may thus be initiated. The sensor signal may be designed as a function of the movement, preferably as a function of the stroke. The sensor signal may have a constant pattern between the first and second end position which is preferably essentially linear. Cross-fading between the signals, generated by the first and/or second wing structure, may accordingly take place. The stroke may thus be determined particularly accurately. In other words, the sensor signal may be proportional to the stroke. It may be provided that nonlinearities are compensated for by linearization, for example by calibration and/or by applying a look-up table.

With regard to a method according to the invention, the same advantages result as previously described with regard to a sensor according to the invention (first aspect).

According to a third aspect, the above object is further achieved by a computer program product according to the invention that includes commands which, when the computer program product is executed by a computer, prompt the computer to implement the method according to the second aspect.

With regard to a computer program product according to the invention, the same advantages result as previously described with regard to the first and/or second aspect.

According to a fourth aspect, the above object is further achieved by a computer-readable data medium according to the invention, in which commands are stored which, when executed by a computer, prompt the computer to carry out the method.

With regard to a computer-readable data medium according to the invention, the same advantages result as previously described with regard to the first, second, and/or third aspect.

According to a fifth aspect, the above object is further achieved by a control unit according to the invention which includes a processing unit, and a memory unit in which commands are stored which, when executed at least in part by the processing unit, carry out a method according to the second aspect.

For example, a drive device of the vehicle may be controlled and/or regulated by the control unit, in particular as a function of the sensor signal, in particular when the sensor is a sensor that is coupled to an accelerator pedal of the vehicle. It may also be provided to supply the sensor signal to further control units of the vehicle to allow further processing.

With regard to a control unit according to the invention, the same advantages result as previously described with regard to the sensor according to the invention and/or a method according to the invention and/or a computer program product according to the invention and/or a computer-readable data medium according to the invention.

According to a sixth aspect, the above object is further achieved by a vehicle according to the invention which includes a control unit according to the fifth aspect and/or a sensor according to the first aspect.

With regard to a vehicle according to the invention, the same advantages result as previously described with regard to the first, second, third, fourth, and/or fifth aspect.

A sensor according to the invention may be used in particular for the pedals of a vehicle. This may be advantageous for future vehicles, which in particular may be increasingly driven autonomously. The X-by-wire systems with their sensors in general may allow new options. Thus, in the future, using these sensors, pedals may be possible which have only a short stroke and/or which may be well integrated into the floor of the passenger compartment, for example. Due to the flat design and/or the lack of rotation (active rotation), introduction in a particularly space-saving manner may take place, in particular for a predefined size of installation space.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a vehicle;

FIG. 2 shows a sensor;

FIG. 3 shows a sensor; and

FIG. 4 shows a method

### DETAILED DESCRIPTION

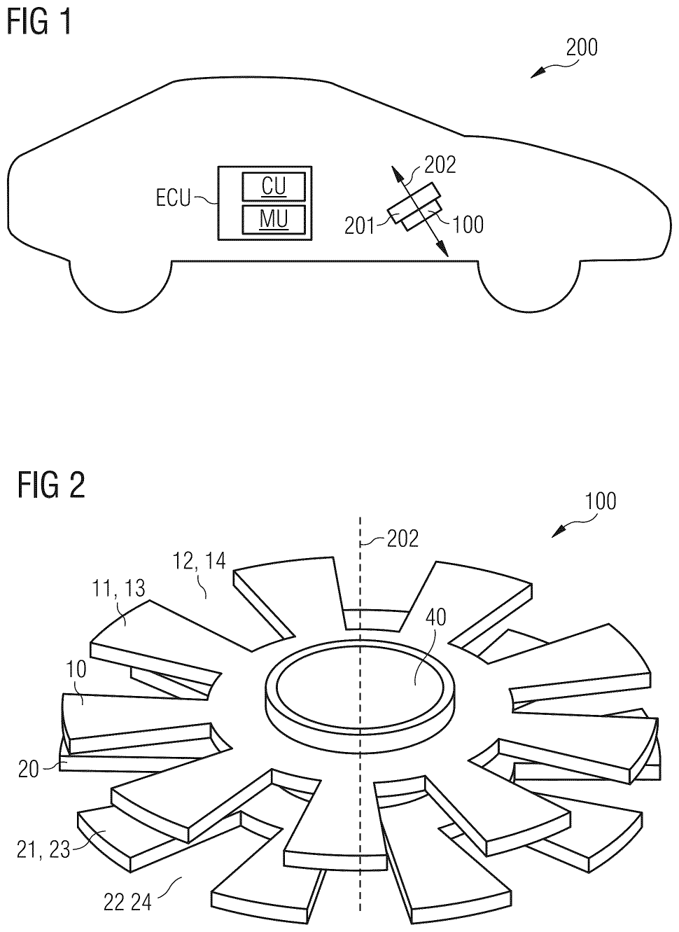

FIG. 1 shows a vehicle 200 that includes a control unit ECU with a processing unit CU and a memory unit MU. The vehicle 200 also includes a pedal 201 that is coupled to a sensor 100. The sensor 100 can sense the stroke of the pedal 201 along a stroke direction 202.

FIG. 2 shows a sensor 100 that includes a first wing structure 10 and a second wing structure 20. The sensor 100 may be symmetrical with respect to the stroke direction 202. The sleeve 40, which is preferably connected, in particular rotatably fixedly connected, to the first and/or second wing structure 10, 20, as well as the first and/or second wing structure 10, 20 may be symmetrical. The first wing structure 10 includes multiple first wings 11 and multiple first wing gaps 12. The first number of wings 13 is equal to nine, and the first number of wing gaps 14 is equal to nine. The second wing structure 20 includes multiple second wings 21 and multiple second wing gaps 22. The second number of wings 23 is equal to nine, and the second number of wing gaps 24 is equal to nine. The first wing structure 10 and the second wing structure 20 have an annular area that adjoins the sleeve 40. The first wings 11 and the second wings 21 are not in congruence. Accordingly, the first wing structure 10 and the second wing structure 20 may be rotated with respect to one another, for example, in such a way that up to approximately 50% of the second wings 21 are covered by the first wings 11 along the stroke direction 202 (for example, from above in the present case). Conversely, up to approximately 50% of the first wings 11 may be covered by the second wings 21 along the stroke direction 202 (for example, observed from below here).

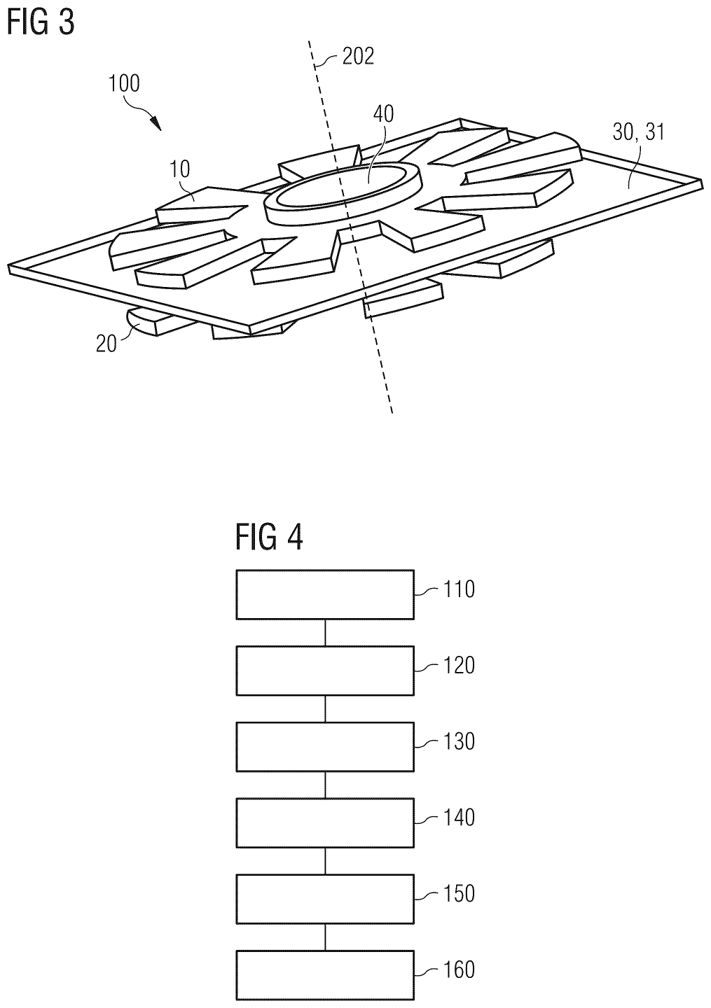

FIG. 3 shows a sensor 100 with a first wing structure 10 and a second wing structure 20 as well as a sleeve 40, in particular according to FIG. 2. In addition, a sensor circuit board 30, which in particular includes at least one sensor element 31, is illustrated. The sensor circuit board 30 is situated between the first wing structure 10 and the second wing structure 20, wherein the surface area extension, in particular perpendicular to a stroke direction 202, is situated in parallel to the first wing structure 10, the second wing structure 20, and the sensor circuit board 30. The stroke direction 202 may be regarded as the symmetry axis for the first wing structure 10, the second wing structure 20, the sensor circuit board 30, and/or the sleeve 40. The sensor circuit board 30 is preferably essentially stationary, while the first wing structure 10, the second wing structure 20, and/or the sleeve 40 are/is displaceable relative thereto along, preferably exclusively along, the stroke direction 202. The displacement may be reversible, and may preferably take place between a first end point in which the first wing structure 10 essentially contacts the sensor circuit board 30, and a second end point in which the second wing structure 20 contacts the sensor circuit board 30. The sensor circuit board 30, in particular the at least one sensor element 31, may be designed to sense, in particular inductively, the stroke movement. A corresponding sensor signal may be relayed to a control unit ECU. For example, a drive device of the vehicle 200 may thus be controlled and/or regulated as a function of the sensor signal, in particular when the sensor 100 is a sensor 100 that is coupled to an accelerator pedal of the vehicle 200.

FIG. 4 shows a method for a sensor 100 for detecting a short-stroke movement, in particular for a pedal 201 of a vehicle 200, comprising: providing 110 a sensor 100; moving 120, in particular by a user, the first wing structure 10 and/or second wing structure 20 along a stroke direction 202 toward a first or second end position; detecting 130 by the sensor circuit board 30 the movement 120 for the sensor-based detection in order to provide a sensor signal; providing 140 the sensor signal to a control unit ECU; processing 150 the sensor signal by the control unit ECU to provide an output signal; and providing 160 the output signal by the control unit ECU, for example for operating a vehicle 200.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A sensor to detect a short-stroke movement for a pedal of a vehicle, the sensor comprising:
a first wing structure;
a second wing structure that is spaced apart from the first wing structure along a stroke direction;
a sensor circuit board for sensor-based detection of a movement of the first wing structure and/or second wing structure, the sensor circuit board being arranged between the first wing structure and the second wing structure; and
a sleeve that connects the first wing structure and the second wing structure, the sleeve being arranged so that it is movable with respect to the sensor circuit board.

2. The sensor according to claim 1, wherein the first wing structure has at least one first wing and at least one first wing gap, and/or the second wing structure has at least one second wing and at least one second wing gap.

3. The sensor according to claim 1, wherein the first wing structure is displaceable, essentially up to the sensor circuit board, along the stroke direction until reaching a first end position, and/or wherein the second wing structure is displaceable, essentially up to the sensor circuit board, along the stroke direction until reaching a second end position.

4. The sensor according to claim 1, wherein the first wing structure and the second wing structure are rotated relative to one another, substantially perpendicular to the stroke direction, about a constant rotation angle, the rotation angle being designed such that the at least one first wing conceals essentially one-half of the at least one second wing gap, and the at least one second wing conceals essentially one-half of the at least one first wing gap.

5. The sensor according to claim 1, wherein the first wing structure and the second wing structure and/or the sleeve are rotatably fixedly situated with respect to the sensor circuit board, wherein the first wing structure, the second wing structure, and the sleeve are connected or connected in one piece.

6. The sensor according to claim 1, wherein the first wing structure and the second wing structure are coupled to one another and displaceable relative to the sensor circuit board along the stroke direction during external application of a stroke movement, by actuating a coupled pedal, and wherein the sensor circuit board does not move during external application of a stroke movement by actuating a coupled pedal.

7. The sensor according to claim 1, wherein the sensor circuit board includes at least one sensor element for detecting an approach of the first wing structure and/or second wing structure.

8. The sensor according to claim 1, wherein the first wing structure and the second wing structure include a conductive material or a metal, and in conjunction with the sensor circuit board form an inductive sensor.

9. The sensor according to claim 1, wherein for the redundant sensing, the sensor implements a further, different, physical measuring method, and wherein the first wing structure and the second wing structure have a conductive design and form a first and second capacitor plate, and together with the sensor circuit board form a three-layer plate capacitor.

10. The sensor according to claim 1, wherein the sleeve has a spring, wherein the stroke of the spring is used to implement a force sensor.

11. A method for a sensor for detecting a short-stroke movement for a pedal of a vehicle, the method comprising:
providing a sensor according to claim 1;
moving, by a user, the first wing structure and/or second wing structure along a stroke direction toward a first or second end position;
detecting by the sensor circuit board the movement for the sensor-based detection in order to provide a sensor signal;
providing the sensor signal to a control unit;
processing the sensor signal by the control unit to provide an output signal; and
providing the output signal by the control unit for operating the vehicle.

12. A computer program product that includes commands which, when the computer program product is executed by a computer, prompt the computer to implement the method according to claim 11.

13. A computer-readable data medium in which commands are stored which, when executed by a computer, prompt the computer to carry out the method according to claim 11.

14. A control unit which includes a processing unit and a memory unit in which commands are stored which, when executed at least in part by the processing unit, carry out the method according to claim 11.

15. A vehicle that includes a sensor according to claim 1.
